(19) United States
(12) Patent Application Publication
(10) Pub. No.: US 2006/0112429 A1
(43) Pub. Date: May 25, 2006

(54) Central exchange for an ip monitoring

(75) Inventors: Christian Polzer, A-Wien (AT); Peter Pregler, Wien (AT); Bernhard Spalt, A-Wien (AT)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/519,920

(22) PCT Filed: Jul. 2, 2002
(86) PCT No.: PCT/EP02/07303

§ 371 Date: Oct. 12, 2005

(51) Int. Cl. G06F 12/14

(52) U.S. Cl. 726/22

(57) ABSTRACT

An efficient and reliable monitoring of users of a telecommunication network is achieved by means of a method for the monitoring of a telecommunication user's data transmitted by a telecommunication network (4). Copies of the data are transmitted to at least one listening station (LEA 6;7;8;9), whereby the data is sent from an exchange device (VSGSN; HSGSN etc.), as a copy, to a monitoring handling device (CIH 14) and sent from said device (CIH 14) to one (7) of a number of addresses of listening stations (LEA 7;8;9) known thereto (CIH 14).

### CLAIM FOR PRIORITY

This application is a national stage of PCT/EP2002/007303, published in the German language on Jan. 15, 2004, which was filed on Jul. 2, 2002.

### TECHNICAL FIELD OF THE INVENTION

The invention relates to methods and devices for enabling data transmitted over a public land mobile network to be monitored.

### BACKGROUND OF THE INVENTION

In the mobile radio interception device according to US2002/078384 A1, each lawful interception gateway (LIG) knows the address of each LEA in order to transmit intercepted user data packets to the LEA via the LIG interface X3.

A means of monitoring calls between mobile radio users that is known to the person skilled in the art, as illustrated in FIG. 1, provides that the communication (conversations or multimedia data transmission) between two mobile radio users of one or more public land mobile networks is monitored in that the user data transmitted between the mobile radio users, while on its way through (at least) one public land mobile network, is copied in a switching device (for example SGSN) which has stored a list containing identities of users subject to call-tapping (MSISDN and/or IMSI and/or IMEI) and the copied user data is transmitted via an interface (=border gateway) to monitoring devices belonging to the secret intelligence services, federal border police, police, etc. Since there are a number of government agencies in a number of local offices that can be responsible for monitoring mobile radio users, the copied data is transmitted by switching devices which copy the data to be intercepted to further switching devices (border gateways) at network gateways of the public land mobile network, which gateways each set up a secure connection, such as, for example, an IPsec tunnel over the Internet etc., to one of the listening stations LEA (of the police or the federal border police, etc.), via which secure connection the data is transmitted in encrypted form to the listening station responsible. As the exchanges carrying out the transmission to the listening stations LEA at borders of a public land mobile network are to be provided at least once per public land mobile network and the transmission is performed separately to each listening station LEA, a key management means is required in each of these interface switching devices (border gateways) for each of the listening stations.

FIG. 1 is a block diagram showing a mobile radio terminal device 1 (a mobile station, a communicator etc.) which communicates with a further user (14) via an air interface transmission device (RNC or BS) 2 and via a switching device (VSGSN etc.) 3 of a first public land mobile network 4 and possibly a further public land mobile network or a fixed network or via an Internet access point over the Internet (http/wap etc.). In the example shown in FIG. 1, it is made possible for the competent government agencies in each case (police/federal border police/secret intelligence service etc.), each having a listening station LEA 6, 7, 8, 9, to monitor calls of users 1 over a public land mobile network 4 in such a way that data representing the call (or the multimedia transmission over the Internet, etc.) is identified (during registration or by monitoring of the data stream) on its way through the public land mobile network 4 by a switching device (SGSN or VSGSN or HSGSN or other exchange V) 3 (insofar as said data originates from devices or persons (1) to be monitored according to a list held in the exchange 3) and a copy of the data is transmitted to an interface switching device (border gateway) 11 which in turn transmits the copied data in a secure tunnel, for example an IPsec tunnel, to the competent government agency's listening station (bugging devices with computers or recording devices or telephone etc.) responsible for monitoring said user (1) or his terminal device. For this purpose, there is provided in each public land mobile network at least one interface switching device (border gateway) 11, 12 which sets up a separate connection in each case to each of the listening stations 6 to 9.

As the transmission between the interface switching devices (border gateways) 11, 12 and the listening stations 7 to 9 is ideally to be executed in an intercept-proof manner, it takes place for example in encrypted form, with keys to be used for the transmission having to be administered separately in each switching device 11, 12 for each listening station 6 to 9 (key management).

### SUMMARY OF THE INVENTION

The present invention enables the monitoring of data to be intercepted which is associated with users of a public land mobile network in an efficient and reliable manner.

In one embodiment, the monitoring handling device (=Central Interception Handler CIH) via which data to be intercepted is transmitted to listening stations of the different government agencies responsible considerably simplifies key management compared with the previously practised solution of individual connections from listening stations LEA to interface switching devices (border gateways). Nevertheless, the transmission of the intercepted data to the listening devices is still very secure and is also possible for example via the Internet, since (in an easy-to-administer manner according to the invention) an encrypted transmission can take place from the monitoring handling device CIH to the listening stations LEA. At the same time it is possible for one monitoring handling device CIH to be used per public land mobile network or by a number of public land mobile networks, for example, or alternatively a plurality of monitoring handling devices can be used for one public land mobile network.

### BRIEF DESCRIPTION OF THE DRAWINGS

The invention will be described in more detail below with reference to the exemplary embodiments illustrated in the drawings, in which:

FIG. 1 is a block diagram showing the monitoring of user data transmitted over a public land mobile network according to the prior art.

FIG. 2 is a block diagram showing the monitoring of data transmitted over a public land mobile network according to the invention having a central monitoring handling device CIH.

### DETAILED DESCRIPTION OF THE INVENTION

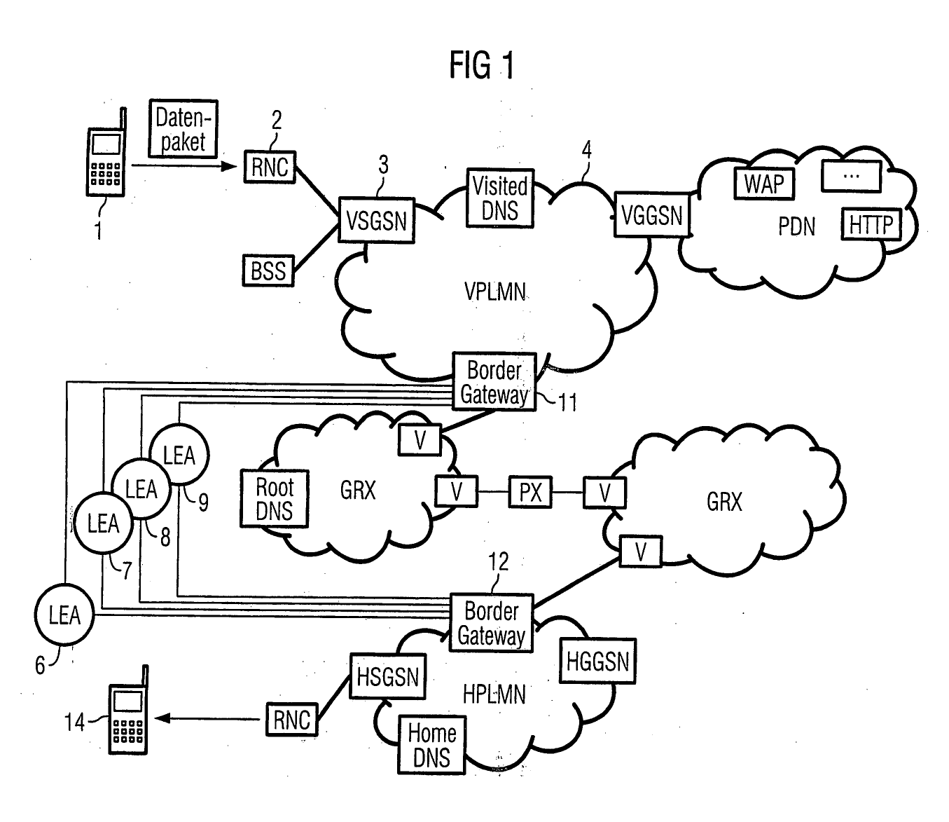

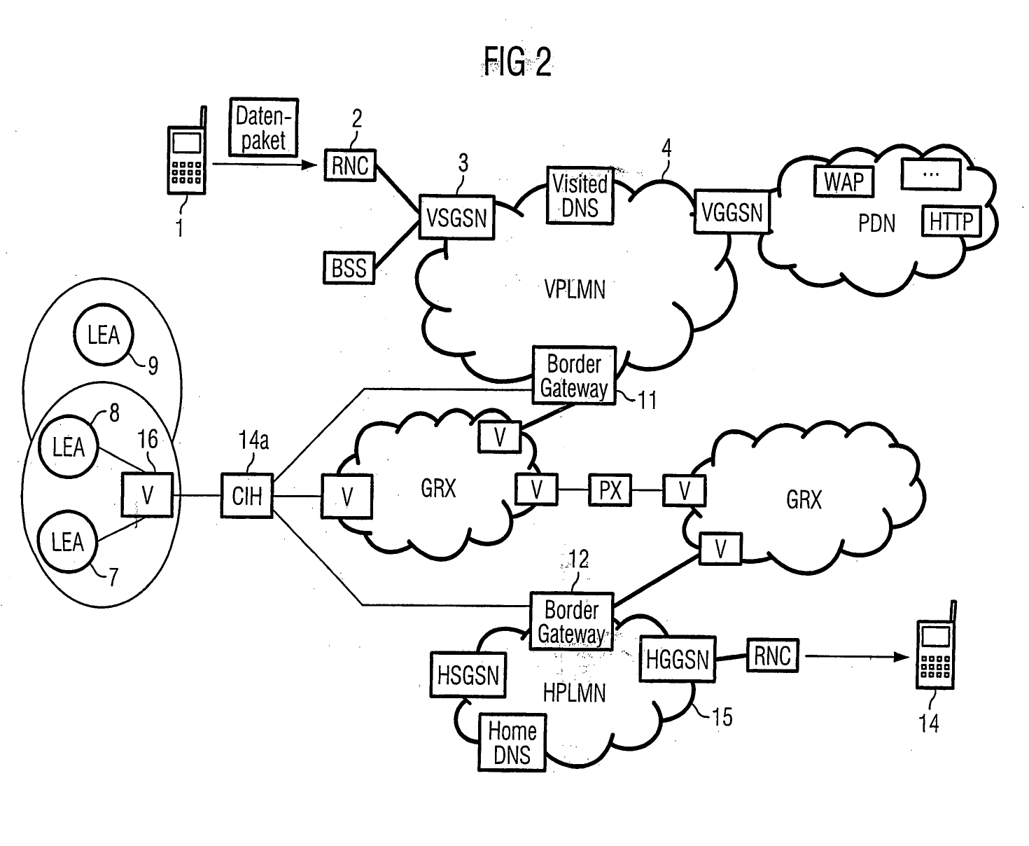

According to FIG. 2, the monitoring of data transmitted over a public land mobile network is supported by a monitoring handling device CIH 14 which considerably simplifies the key management for the secure (encrypted) transmission over a packet-switched network (for example by means of IPsec). As already explained in relation to FIG. 1, in the example shown in FIG. 2 data (voice data or other user data) of a mobile radio user is also transmitted over a public land mobile network (or some other telecommunication network) by means of packet switching to a further telecommunication network (public land mobile network, or fixed network, or Internet, or other packet-switched network). On its way through the telecommunication network 4 the data (data packets) is copied by a switching device (which has stored a table of users to be monitored) and the copies of the data are transmitted via a switching device (border gateway) to listening stations LEA. In the process, however, according to the invention a tunnel will be set up, not between the interface switching devices (border gateways 11, 12) and the listening stations 6, 7, 8, 9, but between the interface switching device 11 (or 12) and a central monitoring handling device CIH 14 which performs a secure transmission (for example using the Internet Protocol or in some other packet-switched protocol over the Internet or another network) to the listening station 7 responsible for this user. For this purpose the monitoring device 14 has a table of addresses (IP addresses) of all the listening stations LEA 6, 7, 8, 9.

In addition the monitoring handling device CIH 14 has a memory (or access to a memory) containing a list of keys, with at least one key being stored for a specific listening station LEA 6/7/8/9 in each case, by means of which key the intercepted data is to be transmitted to this listening station 6/7/8/9 in encrypted form. In the example shown, the data is transmitted by the monitoring handling device 14 to the respective competent (at least one) listening station 6, 7, 8, 9 for all listening stations via the same packet-switched switching device (router V) 16.

Advantageously, according to the invention the address (IP address etc.) of the competent listening station LEA 6/7/8/9 is known by the monitoring device CIH 14, and not to each interface switching device (border gateway) 11, 12 and the key management also takes place in the monitoring handling device 14 (Central Interception Handler CIH).

Necessary address translations are possible based on a list of the assignments in the CIH.

The transmission of the data between the interface switching devices (border gateways) 11, 12 of a network takes place for example over a secure connection/IPsec tunnel between switching devices (border gateways) and the monitoring handling device 14. The monitoring handling device CIH 14 can be part of the network in which one or all of the listening stations 6 to 9 are disposed, in other words can be located in this network.

What is claimed is:

1. A method for enabling the monitoring of data associated with a telecommunication user, comprising:
transmitting the data over a telecommunication network, by transmission of copies of the data to at least one listening station;
sending a copy of the data by a switching device to a monitoring handling device and is sent by the handling device to one of a number of addresses of the at least one listening stations; and
accessing a memory, using the monitoring handling device, including a list of keys for the at least one listening stations and transmitting data in encrypted form to one of the at least one listening stations using the key for the at least one listening stations.

2. The method according to claim 1, wherein
the monitoring handling device knows the addresses of the at least one listening stations, and stores the addresses in a table.

3. The method according to claim 1, wherein
the telecommunication network is a public land mobile network.

4. The method according to claim 1, wherein
the telecommunication network is a packet-switched network.

5. The method according to claim 1, wherein
the switching devices send the copies of the data to be intercepted to an interface switching device which knows the address of the monitoring handling device, and stores the address in a memory.

6. The method according to claim 1, wherein
the at least one listening stations have different addresses which are known to the monitoring handling device.

7. The method according to claim 1, wherein
the monitoring handling device is located in the same network as the listening stations.

8. The method according to claim 1, wherein
a security tunnel is set up between the monitoring handling device and the interface switching devices or will be set up to monitoring a call.

9. A device, comprising:
an interface to at least one switching device for receiving data to be intercepted;
a memory including a list of addresses and keys of a plurality of listening stations;
an interface for transmitting data to be intercepted from a terminal device, the data having been received by a switching device via the first interface, to an IP address of one of the listening stations, the address having been identified based on an identity of the user and the list stored in a memory in the device.
